(19) United States
(12) Patent Application Publication
(10) Pub. No.: US 2021/0354297 A1
(43) Pub. Date: Nov. 18, 2021

(54) Automatic Depalletizing System

(71) Applicants: Tyco Electronics (Shanghai) Co. Ltd., Shanghai (CN); TE Connectivity Services GmbH, Schaffhausen (CH)

(72) Inventors: Yingcong Deng, Shanghai (CN); Dandan Zhang, Shanghai (CN); Qing Zhou, Shanghai (CN); Fengchun Xie, Shanghai (CN); Roberto Francisco-Yi Lu, Bellevue, WA (US); Lvhai Hu, Shanghai (CN); Lei Yang, Shanghai (CN); Ye Zhang, Shanghai (CN); Ming Ni, Shanghai (CN); Dong Xu, Shanghai (CN)

(73) Assignees: Tyco Electronics (Shanghai) Co. Ltd., Shanghai (CN); TE Connectivity Services GmbH, Schaffhausen (CH)

(21) Appl. No.: 17/320,416

(22) Filed: May 14, 2021

(30) Foreign Application Priority Data
May 14, 2020 (CN) 202010408040.5

(51) Int. Cl. B25J 9/16; B25J 13/08; B25J 19/02

(52) U.S. Cl. CPC B25J 9/1687; B25J 19/023; B25J 13/089; B25J 9/1612

(57) ABSTRACT

An automatic depalletizing system comprises a robot including a gripper adapted to grip a logistics box and to unload logistics boxes stacked on a pallet. The system further includes a three-dimensional camera adapted to identify a position and an orientation of the logistics boxes so as to guide the robot to unload the logistics boxes from the pallet in a sequential manner.

### CROSS-REFERENCE TO RELATED APPLICATIONS

This application claims the benefit 35 U.S.C. § 119 to Chinese Patent Application No. 202010408040.5, filed on May 14, 2020, the entire disclosure of which is incorporated herein by reference.

### FIELD OF THE INVENTION

The present disclosure relates to an automatic depalletizing system, in particular to an automatic depalletizing system useful for the logistics storage industry.

### BACKGROUND

Products and other goods are typically stored in some form of container, often in logistics boxes, wherein they are transported to a warehouse for storage on a pallet. Once received, it is necessary to unload the logistics boxes from the pallet, for example, so as to check the condition of the unloaded logistics boxes, identify their information, and sort the boxes according to the identified information. In the prior art, the unloading of the logistics boxes from the pallet and the inspection of the logistics boxes are usually realized through manual processing, which is time consuming and potentially inaccurate, and thus lacks efficiency.

Accordingly, there is a need for improved systems and methods for automatically and accurately depalletize containers or boxes.

### SUMMARY

In one embodiment of the present disclosure, an automatic depalletizing system comprises a robot including a gripper adapted to grip a container or a logistics box and to unload logistics boxes stacked on a pallet. The system further includes a three-dimensional camera adapted to identify a position and an orientation of the logistics boxes so as to guide the robot to unload the logistics boxes from the pallet in a sequential manner.

### BRIEF DESCRIPTION OF THE DRAWINGS

The invention will now be described by way of example with reference to the accompanying FIGURE, of which:

FIG. 1 schematically shows an automatic depalletizing system according to an exemplary embodiment of the present disclosure.

### DETAILED DESCRIPTION OF THE EMBODIMENTS

Exemplary embodiments of the present disclosure will be described hereinafter in detail with reference to the attached drawings, wherein the same or similar reference numerals refer to the same or similar elements. The present disclosure may, however, be embodied in many different forms and should not be construed as being limited to the embodiment set forth herein; rather, these embodiments are provided so that the present disclosure will be thorough and complete, and will fully convey the concept of the present disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the present disclosure, an automatic depalletizing system may automatically realize the unloading, inspection, identification and sorting of containers, such as logistics boxes, thereby saving the labor cost, and greatly improving the warehousing efficiency of the logistics boxes. According to a general technical concept of the present disclosure, the automatic depalletizing system includes a robot having a gripper adapted to grip or grab a logistics box, or other container, to unload the logistics boxes stacked on a pallet, and a three-dimensional camera adapted to identify the position and orientation of the logistics boxes so as to guide the robot to unload the logistics boxes from the pallet one by one or sequentially.

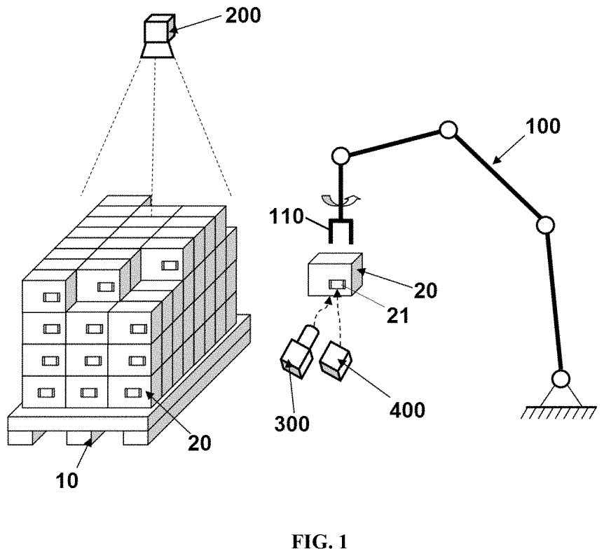

FIG. 1 schematically shows an automatic depalletizing system according to an exemplary embodiment of the present disclosure. As shown, in the illustrated embodiment, the automatic depalletizing system includes a robot 100 and a three-dimensional camera 200. The robot 100 has a grabber or gripper 110 adapted to grab containers or logistics boxes 20 and to unload the logistics boxes 20 stacked on the pallet 10. The three-dimensional camera 200 is adapted to identify the position and orientation of the logistics boxes 20 so as to guide the robot 100 to unload the logistics boxes 20 from the pallet 10 one by one.

As shown in FIG. 1, in the illustrated embodiment, the automatic depalletizing system further includes a two-dimensional camera 300, which is adapted to inspect the logistics box 20 grabbed by the robot 100 so as to determine whether the logistics box 20 is intact, or its general condition.

As shown in FIG. 1, in the illustrated embodiment, the robot 100 is adapted to rotate the grabbed logistics box 20 under the guidance of the three-dimensional camera 200 such that multiple surfaces of the grabbed logistics box 20 are orientated to face the two-dimensional camera 300 one by one, so as to inspect the multiple surfaces of the grabbed logistics box 20 one by one.

As shown in FIG. 1, in the illustrated embodiment, the robot 100 is further adapted to adjust, under the guidance of the three-dimensional camera 200, the distance between the inspected surface of the grabbed logistics box 20 and the two-dimensional camera 300. In this way, the distance between the inspected surface and the two-dimensional camera 300 may be adjusted to be equal to the predetermined ideal distance. That is, the inspected surface is located on the focal plane of the two-dimensional camera 300. In this way, it can be ensured that the two-dimensional camera 300 can capture a clear image, so that the logistics box 20 can be inspected reliably.

As shown in FIG. 1, in the illustrated embodiment, the robot 100 is further adapted to adjust, under the guidance of the three-dimensional camera 200, the orientation of the inspected surface of the grabbed logistics box 20 relative to the two-dimensional camera 300, so as to make the surface to be inspected perpendicular to the optical axis of the two-dimensional camera 300.

As shown in FIG. 1, in the illustrated embodiment, the automatic depalletizing system further includes a code or barcode reader 400, which is adapted to read a barcode 21 or other unique identifier pasted or otherwise attached on the surface of the grabbed logistics box 20. The barcode 21 contains classification information of the logistics box 20. The robot 100 is adapted to sort the logistics boxes 20 according to the classification information read by the barcode reader 400 so as to complete the sorting of the logistics boxes 20.

As shown in FIG. 1, in the illustrated embodiment, while the two-dimensional camera 300 is used to inspect the multiple surfaces of the grabbed logistics box 20 one by one, the code reader 400 is used to scan each surface of the grabbed logistics box 20 until the barcode 21 is read. In the illustrated embodiment, the two-dimensional camera 300 and the barcode reader 400 are located on the same side or different sides of the grabbed logistics box 20.

As shown in FIG. 1, in the illustrated embodiment, the grabber 110 of the robot 100 is adapted to grab the logistics boxes 20 of different sizes, and the three-dimensional camera 200 is also adapted to identify the size of the logistics boxes 20. The robot 100 is adapted to adjust the grabber 110 according to the identified size of the logistics box 20 so as to grab logistics boxes 20 of different sizes. In this way, the automatic depalletizing system can be applied to the storage processing of logistics boxes or containers of different sizes.

As further shown in FIG. 1, in the illustrated embodiment, the robot 100 is a multi-degree-of-freedom robot, which can realize the translation of the grabbed logistics box 20 in at least three different directions and the rotation of the grabbed logistics box 20 around the axes in three different directions. The aforementioned three different directions are perpendicular to each other.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

The present disclosure has been described with reference to the accompanying drawings, and the embodiments of the present disclosure are intended to be illustrative of the preferred embodiments of the present disclosure and should not be considered limitation to the present disclosure.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element or step recited in the singular and proceeded with the word “a” or “an” should be understood as not excluding plural of said elements or steps. In addition, any reference numerals of the claims should not be considered as limiting the scope of the disclosure.

What is claimed is:

1. An automatic depalletizing system, comprising:
a robot including a gripper adapted to grip a container and to unload containers stacked on a pallet; and
a three-dimensional camera adapted to identify a position and an orientation of the container so as to guide the robot to unload the containers from the pallet in a sequential manner.

2. The automatic depalletizing system according to claim 1, further comprising a two-dimensional camera adapted to inspect a container gripped by the robot so as to determine whether the container is intact or not.

3. The automatic depalletizing system according to claim 2, wherein the robot is adapted to rotate a gripped container under a guidance of the three-dimensional camera, such that multiple surfaces of the gripped container are orientated to face the two-dimensional camera one by one, so as to inspect the multiple surfaces of the gripped container.

4. The automatic depalletizing system according to claim 3, wherein the robot is further adapted to adjust, under a guidance of the three-dimensional camera, a distance between an inspected surface of the gripped container and the two-dimensional camera, such that the distance between the inspected surface and the two-dimensional camera is adjusted to be equal to a predetermined ideal distance.

5. The automatic depalletizing system according to claim 4, wherein the inspected surface is located on a focal plane of the two-dimensional camera.

6. The automatic depalletizing system according to claim 3, wherein the robot is further adapted to adjust, under a guidance of the three-dimensional camera, an orientation of an inspected surface of the gripped container relative to the two-dimensional camera, so as to make the inspected surface perpendicular to an optical axis of the two-dimensional camera.

7. The automatic depalletizing system according to claim 3, wherein the automatic depalletizing system further includes a code reader adapted to read a barcode on a surface of the gripped container, the barcode containing classification information of the gripped container, the robot adapted to sort the container according to the classification information read by the barcode reader so as to complete sorting of the containers.

8. The automatic depalletizing system according to claim 7, wherein while the two-dimensional camera sequentially inspects the multiple surfaces of the gripped container, the code reader scans each surface of the gripped container until the barcode is read.

9. The automatic depalletizing system according to claim 7, wherein the two-dimensional camera and the barcode reader are configured to be located on a same side or different sides of the gripped container.

10. The automatic depalletizing system according to claim 1, wherein:
the gripper of the robot is adapted to grip containers of different sizes;
the three-dimensional camera is adapted to identify a size of the container; and
the robot is adapted to adjust the gripper according to the identified size of the container so as to grip containers of different sizes.

11. The automatic depalletizing system according to claim 1, wherein the robot is a multi-degree-of-freedom robot, which realizes a translation of a gripped container in three different directions and a rotation of the gripped logistics box around axes in three different directions, the three different directions being perpendicular to each other.

12. An automatic depalletizing system, comprising:
a robot including a gripper for gripping a container and to unload a plurality of containers from a pallet;
a three-dimensional camera identifying a position and an orientation of a container so as to guide the robot to unload the containers from the pallet in a sequential manner;
a two-dimensional camera adapted to inspect a container gripped by the robot so as to determine a condition of the container; and
a code reader adapted to read a barcode on a surface of the gripped container, the barcode containing classification information of the gripped container.

13. The automatic depalletizing system according to claim 12, wherein the robot rotates a gripped container under a guidance of the three-dimensional camera for orienting multiple surfaces of the gripped container to face the two-dimensional camera in a sequential manner so as to inspect the multiple surfaces of the gripped container.

14. The automatic depalletizing system according to claim 13, wherein the robot adjusts, under a guidance of the three-dimensional camera, a position between an inspected surface of the gripped container and the two-dimensional camera such that the distance between the inspected surface and the two-dimensional camera is equal to a predetermined ideal position.

15. The automatic depalletizing system according to claim 14, wherein the inspected surface is located on a focal plane of the two-dimensional camera.

16. The automatic depalletizing system according to claim 14, wherein the in the predetermined ideal position the inspected surface is perpendicular to an optical axis of the two-dimensional camera.

17. The automatic depalletizing system according to claim 13, wherein the robot sorts the container according to the classification information read by the barcode reader.

18. The automatic depalletizing system according to claim 17, wherein the two-dimensional camera inspects each of the multiple surfaces of the gripped container as the code reader simultaneously scans each of the multiple surfaces until the barcode is read.

19. The automatic depalletizing system according to claim 12, wherein the two-dimensional camera and the barcode reader are located on a same side of the gripped container.

20. The automatic depalletizing system according to claim 12, wherein the two-dimensional camera and the barcode reader are located on different sides of the gripped container.
